(19) United States
(12) Patent Application Publication
(10) Pub. No.: US 2024/0361444 A1
(43) Pub. Date: Oct. 31, 2024

(54) METHOD FOR RADAR ANGLE ESTIMATION

(71) Applicant: Robert Bosch GmbH, Stuttgart (DE)

(72) Inventors: Benedikt Loesch, Stuttgart (DE); Arthur Hipke, Leonberg (DE); Jingyuan Qu, Korntal-Muenchingen (DE)

(21) Appl. No.: 18/603,860

(22) Filed: Mar. 13, 2024

(30) Foreign Application Priority Data
Apr. 26, 2023 (DE) 10 2023 203 873.0

(51) Int. Cl. G01S 13/48; G01S 7/41; G01S 13/00; G01S 13/46; G01S 13/931

(52) U.S. Cl. CPC G01S 13/48; G01S 7/411; G01S 13/006; G01S 13/931; G01S 2013/462

(57) ABSTRACT

A method for angle estimation based on signals of a radar sensor with angular resolution in at least one dimension. The radar sensor includes a MIMO-enabled antenna array with at least three transmitting antennas and at least three receiving antennas. A cross-path model represented by a control matrix and models reflections of transmitted and/or received signals on a reflective surface is used to estimate a location angle of a radar target. The control matrix includes a Kronecker product Aₜₓ ⊗Aᵣₓ of two submatrices, one, Aₜₓ, representing the arrangement of the transmitting antennas and the other, Aᵣₓ, representing the arrangement of the receiving antennas. For calculating a DML estimation function, a matrix product Y=A^{H}ᵣₓ·X·A*ₜₓ is calculated approximately using an FFT from the submatrices and a reception matrix X that specifies the complex amplitudes of the signals received with different combinations of antennas.

### CROSS REFERENCE

The present application claims the benefit under 35 U.S.C. § 119 of German Patent Application No. DE 10 2023 203 873.0 filed on Apr. 26, 2023, which is expressly incorporated herein by reference in its entirety.

### FIELD

The present invention relates to a method for angle estimation on the basis of signals of a radar sensor.

In particular, the present invention relates to methods for radar sensors used in driver assistance systems of motor vehicles for sensing the environment.

### BACKGROUND INFORMATION

In driver assistance systems, in addition to the distance and the relative speed of the located objects, the azimuth angle and the elevation angle are also important since, on the basis of this angle information, a lane assignment can be carried out and a statement on the relevance of the target (can be driven over, can be driven against, can be driven under) can be made. Azimuth and elevation angles of the targets can be ascertained from amplitude and/or phase differences of transmitting and/or receiving antennas of an antenna array. In order to improve the accuracy and separability of the angle estimation, the MIMO principle (multiple input multiple output) is often used for radar sensors. In so doing, multiple transmitting antennas and multiple receiving antennas are used, unlike in the case of traditional SIMO radars (single input multiple output), which only use one transmitting antenna and multiple receiving antennas. In the angle estimation, the receive signals are compared to a previously measured angle-dependent antenna radiation pattern. In the event that only one target is in a (d,v) cell (distance/velocity cell), the estimated angle results as the position of the best match between the receive signal and the antenna radiation pattern.

M. Wintermantel: “Radar system comprising overlapping transmitter and receiver antennas” as well as U.S. Pat. No. 8,436,763 B2 describe a MIMO radar sensor that uses the MIMO principle with code multiplex and two transmitting antennas to improve the azimuth angle estimation. In the case of multipath propagation due to reflections on, for example, a guard rail or the road surface, four different paths of signal propagation occur, namely, a path on which the signal propagates without reflection directly from the radar sensor to the object and back to the radar sensor, a path in which the signal propagates directly from the radar sensor to the object but is reflected on the return path to the radar sensor, a path in which the signal is reflected on the way to the object and travels without reflection directly to the radar sensor on the return path, and finally a path in which the signal is reflected on the way to the object and the radar echo is reflected once again on the same surface on the return path. Signal models representing this scenario are called cross-path models.

If multipath propagation is ignored in the signal model, a MIMO angle estimation provides incorrect estimated values with errors of multiple angular degrees. This can then lead to undesirable system behavior, such as adjacent lane interferences or target object losses.

Multipath propagation also has the result that the virtual array model must not be used in MIMO beamforming (beamforming of both the transmission and the reception beam). F. Engels, P. Heidenreich, M. Wintermantel, L. Stacker, M. Al Kadi and A. M. Zoubir, “Automotive Radar Signal Processing: Research Directions and Practical Challenges,” in IEEE Journal of Selected Topics in Signal Processing, doi: 10.1109/JSTSP.2021.3063666 describes, as a remedial measure, beamforming with separate grids for the transmission angle (direction-of-departure (DOD)) and the reception angle (direction-of-arrival (DOA)).

German Patent Application No. DE 10 2021 212 393.7 describes a method for a radar sensor comprising a MIMO-enabled antenna array with at least three transmitting antennas and at least three receiving antennas, wherein a cross-path model that is represented by a control matrix and also models reflections of transmitted and/or received signals on a reflective surface is used to estimate the location angle of a radar target. On the basis of the cross-path model, a transmit-side and receive-side beamforming operation is calculated precisely. To this end, the control matrix is broken down into a Kronecker product of two submatrices, one representing the arrangement of the transmitting antennas and the other representing the arrangement of the receiving antennas. In order to calculate a DML estimation function, a matrix product Y is then calculated from the submatrices and a reception matrix that specifies the complex amplitudes of the signals received with different combinations of transmitting and receiving antennas.

In this method, the entire multipath signal model is used. Although this allows robust angle estimation, it requires considerable computational effort and thus high computing capacity due to the required number of transmitting and receiving antennas (at least three each). With only two transmitting antennas, the advantage of MIMO (enlarged virtual aperture, improved angle separation) could not be used in multipath propagation, since consideration of the multipath propagation in the signal model falls back on SIMO performance (cf: F. Engels, M. Wintermantel, P. Heidenreich, “Automotive MIMO radar angle estimation in the presence of multipath,” European Radar Conference (EURAD), 2017, pp. 82-85). Analogously, with only two receiving antennas in multipath propagation, a fall back on MISO performance (multiple input single output, i.e., multiple transmitting antennas, one receiving antenna) would occur. As the number of transmitting and receiving antennas increases further, the computational effort increases considerably.

### SUMMARY

An object of the present invention is to make possible a robust, unambiguous and efficient MIMO angle estimation (in azimuth and/or in elevation) even in multipath propagation.

According to the present invention, this object may be achieved by the method of the present invention.

Unlike the method described in German Patent Application No. DE 10 2021 212 393.7, the precise calculation of the matrix product is replaced by a less computationally complex approximate calculation. In so doing, the fact that two conditions under which the approximate calculation provides sufficiently accurate results are fulfilled or can be fulfilled in practice in a good approximation is used. The first of these conditions is that the amplitudes of the signals obtained for different pairings of transmitting and receiving antennas are of equal magnitude, or at least the ratios of the magnitudes relative to one another are angle-independent. This condition is approximately fulfilled if the signal paths to and from the objects to be located are very similar to one another both in length and in the signal attenuation properties, and the transmitting and receiving antennas respectively have identical antenna characteristics. It should thus be avoided that attenuating elements are present in one signal path but not in other signal paths. The second condition is that the phase differences between the signals obtained for different antenna pairings can be correctly described with a model in which only the geometric parameters of the antenna arrays are included. This condition is approximately fulfilled if the positions of the different antennas relative to one another are known exactly and if different refractive indices do not occur in the different signal paths. If these two conditions are fulfilled exactly, the calculation of the matrix product is equivalent to applying a fast Fourier transform (FFT) to the reception matrix. Since efficient algorithms or specialized hardware are available for the fast FFT, the required computational effort is considerably reduced.

Advantageous embodiments and developments of the present invention emerge from the disclosure herein.

According to an example embodiment of the present invention, the arrangement of the transmitting and receiving antennas may be equidistant, for example, with a uniform grid for the transmit array and the receive array. However, with a method referred to as zero insertion/zero padding, it is also possible to replace missing antenna elements on the grid by inserting zeros in the reception matrix and/or to refine the grid by means of zero padding in the FFT, and thus to increase the number of supporting points for the discrete Fourier transform. A method suitable for this purpose is described in Westhues, T. Breddermann, A. von Rhein, S. Kurkute, T. Fei and E. Warsitz, “Low-Complexity Super Resolution Angle Separation for Sparse Antenna Arrays Based on Frequency Domain Maximum Likelihood,” 2022 IEEE Radar Conference (RadarConf22), 2022, pp. 1-6, doi: 10.1109/RadarConf2248738.2022.9764268.

An exemplary embodiment of the present invention is explained in more detail below with reference to the figures.

### BRIEF DESCRIPTION OF THE DRAWINGS

FIG. 1 shows a schematic representation of the analog portion of a radar system, according to an example embodiment of the present invention.

FIG. 2 shows a diagram of an antenna array of the radar system, according to an example embodiment of the present invention.

FIG. 3 shows a diagram illustrating a scenario with multipath propagation, according to an example embodiment of the present invention.

FIG. 4 shows a block diagram for a method according to an example embodiment of the present invention.

FIG. 5 shows a flow chart for a method according to an example embodiment of the present invention.

### DETAILED DESCRIPTION OF EXAMPLE EMBODIMENTS

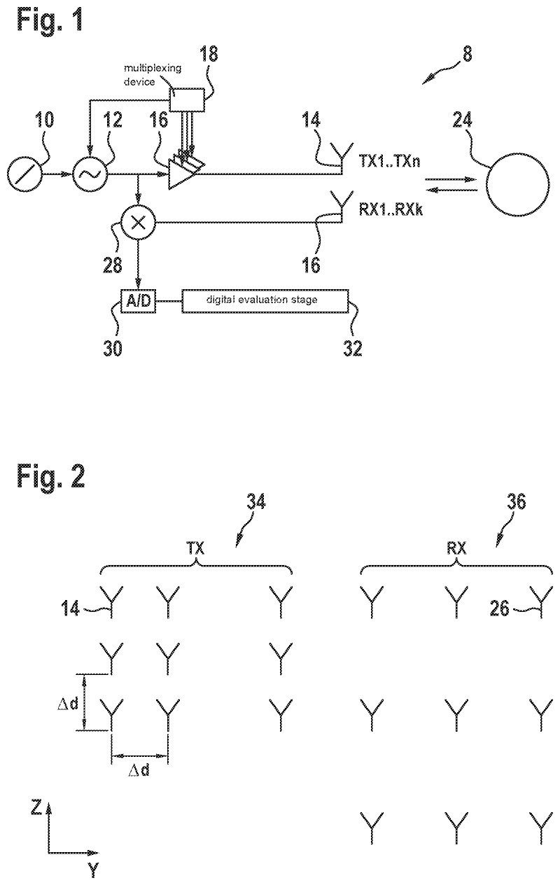

An exemplary embodiment of a radar system with which the method according to the present invention is performed is explained with reference to FIGS. 1 and 2.

FIG. 1 shows, in a schematic and simplified manner, the structure of the analog portion of a radar sensor 8.

A frequency modulation device 10 controls an HF oscillator 12, which generates sequences of signals in the form of frequency ramps for multiple transmitting antennas 14. In each of the multiple transmission channels, an amplifier 16 is arranged, which either blocks the signals or forwards them, amplified, to the associated antenna. The oscillator 12 and the amplifiers 16 are controlled by a multiplexing device 18, for example according to a time and frequency multiplexing scheme, such that each of the transmitting antennas 14 transmits a frequency-modulated signal in a particular frequency subband within particular time slots.

The transmitted signal reflected on an object 24 is received by multiple receiving antennas 26 and, in each reception channel, is mixed by a mixer 28 with a portion of the signal of the HF oscillator 12 and brought into a low-frequency range. An A/D conversion then takes place in the usual manner by an A/D converter 30. The digitized signals are then further processed in a digital evaluation stage 32.

As FIG. 2 shows, the transmitting antennas 14 form a transmit array 34, and the receiving antennas 26 form a receive array 36. In the example shown, both arrays are two-dimensional so that MIMO angle measurements are possible in both azimuth and elevation.

In the receive array 36, the receiving antennas 26 are arranged at regular intervals in an angular resolution direction y, e.g., in the direction of the azimuth. The distances between the individual receiving antennas are so large that, even with a few antennas, a large aperture and a correspondingly high angular resolution is achieved. However, the distances from antenna to antenna are greater than half the wavelength of the radar radiation so that the Nyquist theorem is not fulfilled.

In the example shown here, the receiving antennas 26 are also arranged at regular intervals in elevation (in the angular resolution direction z), and the antenna distances in this direction are also so large that ambiguous subsampling takes place.

In this example, the transmitting antennas 14 of the transmit array 42 are only arranged at regular intervals in elevation, while the grid of the antennas has gaps in azimuth. The grid is so narrow in both dimensions that an unambiguous angle measurement is possible. In exchange, however, the aperture is smaller than in the receive array 44 so that the angular resolution is lower. Specifically, in this example, all antennas of the transmit array and of the receive array in both dimensions are arranged in a uniform grid with the grid dimension Dd, even if they do not completely fill this grid. In the receive array 36, only every second grid point is occupied.

The number of transmitting antennas 14 in each dimension matches the number of receiving antennas in the same dimension.

In the evaluation stage 32, a two-dimensional spectrum in the dimensions distance and relative velocity is first calculated in a conventional manner by means of a Fourier transform. This spectrum can then be used to identify individual objects and to determine their distances and relative velocities. In the case of a single target scenario, i.e., if there is only a single object in each distance/velocity cell, the MIMO model, which is briefly outlined below, can be used for the angle estimation in azimuth and elevation for each object. For simplicity, only the angle estimation in azimuth is considered, in which only the first row of the transmitting antennas 14 in the transmit array 34 and only the first row of the receiving antennas 26 in the receive array 36 have to be used.

Xₙ denotes the three-component vector, the components of which (X_{n,1}, X_{n,2}, X_{n,3}) specify the complex amplitudes of the signals that are transmitted by the nth transmitting antenna 14 and received by the three receiving antennas 26. If d is the distance from antenna element to antenna element, λ is the wavelength of the radar radiation, and s=X_{n,1} is the complex amplitude of the signal that is received by the first receiving antenna (for example, the receiving antenna to the farthest right of FIG. 2), the following relationship applies due to the run length differences between the signals that reach the different receiving antennas 14:

$${x}_{n} ( Θ ) = {s ( 1 , {e}^{- 2 π i ( d / λ ) sin ( Θ )} , {e}^{- 2 π i ( 2 d / λ ) sin ( Θ )} )}^{T} = s {\underline{a}}_{rx} ( Θ )$$

The superscript symbol “T” is to denote the transposition since vectors are written here as row vectors but are to be considered column vectors. The vector aᵣₓ is referred to as the receive control vector. This control vector specifies the geometric properties and wave propagation properties of the receive array.

Accordingly, for the transmit array 34, a control vector aᵣₓ can also be defined, which specifies the run length differences of the optical paths from the transmitting antennas to the object 24.

For the entire MIMO antenna array, the following control vector is obtained:

$$\underline{a} ( Θ ) = {\underline{a}}_{t x} ( Θ ) ⊗ {\underline{a}}_{r x} ( Θ )$$

The symbol ⊗ here means the Kronecker product.

The received signals form a vector x with Nₜₓ·Nᵣₓ components (9 components in this example since, in the direction y, the number Nₜₓ of the transmitting antennas is 3 and the number Nᵣₓ of the receiving antennas is also 3), and the following applies:

$$\underline{x} ( Θ ) = s \underline{a} ( Θ )$$

Knowing the control vector a(Θ) makes it possible to establish a relationship (which is unambiguous under suitable conditions) between the angle q of the object and the received signals x and to deduce the azimuth angle Θ of the object from the amplitude and phase relationships of the received signals. However, since the receiving signals are more or less noisy in practice, the azimuth angle cannot be calculated exactly but can only be estimated, for example by means of a deterministic maximum likelihood estimation (DML).

If this principle is generalized to multitarget estimations, the single angle Θ becomes a vector Θ whose components specify the angles of the different targets, the control vector a becomes a control matrix A, the vector x becomes a reception matrix X (with a respective column for each target), and the following relationship applies:

$$X = A \underline{Θ} \qquad ( 1 )$$

Thus, in the case of two targets with the location angles Θ₁ and Θ₂:

$$X = [ {\underline{a}}_{tx} ( {Θ}_{1} ) ⊗ {\underline{a}}_{cx} ( {Θ}_{1} ) {\underline{a}}_{tx} ( {Θ}_{2} ) ⊗ {\underline{a}}_{rx} ( {Θ}_{2} ) ] \qquad ( 2 )$$

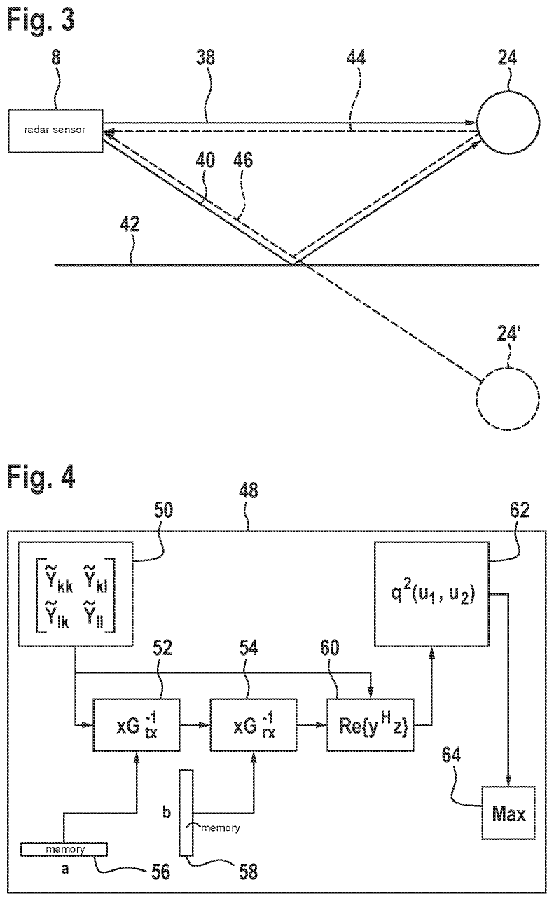

FIG. 3 outlines a scenario characterized by multipath propagation. The signal transmitted by the radar sensor 8 can propagate to the object 24 not only on a direct path 38 but also on an indirect path 40, which first leads to a reflective surface 42, e.g., a guard rail, and is then deflected to the object 24. Likewise, the signal reflected on the object 24 can propagate to the radar sensor 8 not only on a direct path 44 but also on an indirect path 46, on which the signal is also reflected on the surface 42 so that the radar sensor perceives a pseudo mirror object 24′.

In the case of multipath propagation, the complete MIMO signal model is a cross-path model, which has the following form:

$$X = [ {\underline{a}}_{t x} ( {Θ}_{1} ) ⊗ {\underline{a}}_{rx} ( {Θ}_{1} ) {\underline{a}}_{t x} ( {Θ}_{2} ) ⊗ {\underline{a}}_{r x} ( {Θ}_{2} ) {\underline{a}}_{t x} ( {Θ}_{2} ) ⊗ {\underline{a}}_{rx} ( {Θ}_{1} ) {\underline{a}}_{t x} ( {Θ}_{1} ) ⊗ {\underline{a}}_{rx} ( {Θ}_{2} ) ] \qquad ( 3 )$$

Although the last two terms can be combined into a single path due to the reciprocity of the cross-paths, i.e., the path combinations 38, 46 and 40, 44, the computational effort for calculating the reception matrix X is nevertheless greater than in the case of single path propagation.

In order to calculate a DML estimation function q2 (q1, q2), the control matrix A can be broken down into submatrices Aₜₓ and Aᵣₓ as follows:

$$A = {A}_{t x} ( {Θ}_{1} , {Θ}_{2} ) ⊗ {A}_{r x} ( {Θ}_{1} , {Θ}_{2} ) \qquad ( 4 )$$

$${A}_{tx} ( {Θ}_{1} , {Θ}_{2} ) = [ \begin{matrix}{A}_{t x} ( {Θ}_{1} ) & {A}_{t x} ( {Θ}_{2}\end{matrix} ]$$

$${A}_{rx} ( {Θ}_{1} , {Θ}_{2} ) = [ \begin{matrix}{A}_{r x} ( {Θ}_{1} ) & {X}_{r x} ( {Θ}_{2} )\end{matrix} ]$$

From the submatrices and the reception matrix X, a matrix product Y is then calculated.

$$Y ( {Θ}_{1} , {Θ}_{2} ) = {A}_{r x}^{H} ( {Θ}_{1} , {Θ}_{2} ) \cdot X \cdot {A}_{t x}^{⋆} ( {Θ}_{1} , {Θ}_{2} ) \qquad ( 5 )$$

A^{H}ᵣₓ is the Hermitian conjugate matrix to Aᵣₓ, and A* ₜₓ is the complex conjugate matrix to Aₜₓ. If Aₜₓ is an N×2 matrix, Y is an N×N matrix, and A^{H}ᵣₓ is a 2×N matrix, then Y is a 2×2 matrix. The four entries of this matrix Y correspond to the four combinations of transmit-side beamforming in the directions θ₁,θ₂ and receive-side beamforming in the directions θ₁,θ₂.

For the DML estimation function q² (Θ₁, Θ₂), the following calculation rule now applies:

$${q}^{2} ( {q}^{1} , {q}^{2} ) = R e \{ {y}^{H} \cdot z \} \qquad ( 6 )$$

$$y = vec ( Y )$$

$$z = vec ( Z )$$

$$Z = {G}_{rx}^{- 1} \cdot Y \cdot {( {G}_{tx}^{- 1} )}^{*}$$

$${G}_{rx}^{- 1} = \frac{1}{1 - {\vert a \vert}^{2}} ( \begin{matrix}1 & - a \\ - {a}^{*} & 1\end{matrix} )$$

$${G}_{tx}^{- 1} = \frac{1}{1 - {\vert b \vert}^{2}} ( \begin{matrix}1 & - b \\ - {b}^{*} & 1\end{matrix} )$$

$$a = {\underline{a}}_{r x}^{H} ( {Θ}_{1} ) \cdot {a}_{r x} ( {Θ}_{2} )$$

$$b = {\underline{b}}_{r x}^{H} ( {Θ}_{1} ) \cdot {\underline{b}}_{r x} ( {Θ}_{2} )$$

vec (A) denotes the vectorization operator, which arranges the columns of an M×N matrix A one above the other in an MN×1 vector. The variables

$$a , b , \frac{1}{1 - {\vert a \vert}^{2}} and \frac{1}{1 - {\vert b \vert}^{2}}$$

are functions of the angles Θ₁, Θ₂ and depend only on the control vectors aᵣₓ, aₜₓ. They can therefore be calculated once and stored in flash memory before the radar sensor is put into operation.

The relatively complex calculation of the DML estimation function according to the rule (6) can be significantly simplified if the following conditions are at least approximately fulfilled:
angle-independent ratios between the amplitude magnitudes of the receive signals;
relative phases between antennas follow the ideal model according to the position of the antenna elements.

Under these conditions, the entries, needed for all angle combinations, of the matrix Y for an antenna array the antenna elements of which lie on a grid with the grid dimension Δd can be calculated by means of a FFT and zero insertion/zero padding. In doing so, the angle variable Θ is expediently replaced by the variable u=sin (Θ). The control vectors a^{H}ᵣₓ (Θ) and a⁺ₜₓ (Θ) then become vectors āᵣₓ^{H}(u) and āₜₓ*(u).

If the following is defined:

$${Y}_{r x} ( u ) = {\underline{\overline{a}}}_{r x}^{H} ( u ) \cdot X \qquad ( 7 )$$

the following applies to the matrix product Y in a good approximation:

$$Y ( {u}_{1} , {u}_{2} ) \approx [ \begin{matrix}{Y}_{r x} ( {u}_{1} ) \\ {Y}_{r x} ( {u}_{2} )\end{matrix} ] \cdot [ \begin{matrix}{\underline{\overline{a}}}_{tx}^{*} ( {u}_{1} ) & {\underline{\overline{a}}}_{tx}^{*} ( {u}_{2} )\end{matrix} ] = [ \begin{matrix}{Y}_{11} & {Y}_{12} \\ {Y}_{21} & {Y}_{22}\end{matrix} ] \qquad ( 8 )$$

$${Y}_{11} = {Y}_{r x} ( {u}_{1} ) \cdot {\underline{\overline{a}}}_{tx}^{*} ( {u}_{1} ) , {Y}_{12} = {Y}_{r x} ( {u}_{1} ) \cdot {\underline{\overline{a}}}_{tx}^{*} ( {u}_{2} )$$

$${Y}_{21} = {Y}_{r x} ( {u}_{2} ) \cdot {\underline{\overline{a}}}_{tx}^{*} ( {u}_{1} ) , {Y}_{22} = {Y}_{r x} ( {u}_{2} ) \cdot {\underline{\overline{a}}}_{tx}^{*} ( {u}_{2} )$$

“Missing” antenna elements in the grid Δd can be represented by inserting zeros in the reception matrix X. A sufficiently fine grid in u or in the angle θ, for example in order to bring the receive array 36 in FIG. 2 to the finer grid dimension Δd, can be achieved by means of zero padding. In this way, an equidistant 2D grid can be formed in u with N supporting points, and the vectors āᵣₓ^{H}(u) and āₜₓ*(u) can be replaced by a vector a_{FFT} (u), the components of which have the shape e ^{I 2n n Δd u}, wherein the index n passes through the values n=0 to N−1.

The matrix multiplication in (8) is then equivalent to a fast Fourier transform FFT. Overall, the required entries for Y can thus be approximated as follows:

$$\tilde{Y} = F F {T}_{N} ( {( F F {T}_{N} ( \tilde{X} ) )}^{T} ) \qquad ( 9 )$$

Here, \tilde{Y} is a complex N λN matrix, \tilde{X} is the reception matrix filled in by zero insertion/zero padding, and FFTN is an operator acting row by row on a matrix and performing a Fourier transform on the discrete function defined by the matrix components in the relevant row. The two-time application of this operator in (9) thus represents a two-dimensional Fourier transform.

Due to the above two approximations, the values of the variables a and b now no longer depend on θ₁,θ₂ or u₁, u₂ but only on the difference |u₁−u₂|. As a result, the required memory space for

$$a , b , \frac{1}{1 - {\vert a \vert}^{2}} and \frac{1}{1 - {\vert b \vert}^{2}}$$

variables, only a 1D field instead of a 2D field needs to be stored. Gᵣₓ⁻¹ and Gₜₓ⁻¹ likewise depend only on the difference |u₁−u₂|.

Calculation rule (6) is thereby changed as follows:

$${q}^{2} ( {u}_{1} , {u}_{2} ) \approx R e \{ {\overline{y}}^{H} \cdot \overline{z} \} \qquad ( 10 )$$

$$\overline{Y} ( {u}_{1} , {u}_{2} ) = [ \begin{matrix}{\tilde{Y}}_{k k} & {\tilde{Y}}_{k l} \\ {\tilde{Y}}_{l k} & {\tilde{Y}}_{l l}\end{matrix} ]$$

$$\overline{y} = vec ( \overline{Y} ( {u}_{1} , {u}_{2} ) )$$

$$\overline{Z} = {G}_{r x}^{- 1} ( \vert k - l \vert ) \cdot \overline{Y} ( {u}_{1} , {u}_{2} ) \cdot {( {G}_{tx}^{- 1} ( \vert k - l \vert ) )}^{*}$$

$$\overline{z} = v e c ( \overline{Z} )$$

Here, k and l are whole-number indices, each running from 0 to N−1. If Δu=2/(N−1) is the grid dimension in the space of the variables u, u₁ and u₂ can be expressed by k and l as follows:

$${u}_{1} = - 1 + k Δ u {u}_{2} = - 1 + l Δ u \qquad ( 11 )$$

The values of u₁ and u₂ then respectively run from −1 (corresponding to Θ=−90°) to +1 (corresponding to Θ=+90°).

The calculation of the function q² (u₁, u₂) according to (10) can be performed efficiently, whether in the evaluation stage 32 or in an external hardware accelerator.

For each index pair, the four complex values of the 2D FFT results Y (u₁, u₂) must be read from the memory. In addition, the two associated coefficients a,b must be read from a coefficient memory. In this case, a, b only depends on |k−l|, i.e., can be kept constant for multiple index pairs if necessary. The scaling factors

$$\frac{1}{1 - {\vert a \vert}^{2}} , \frac{1}{1 - {\vert b \vert}^{2}}$$

can either be read from a coefficient memory as well or calculated online. For the calculation of q² (u₁, u₂) after the 2D FFT, two complex matrix multiplications (2×2) and the real part of a complex scalar product of length 4 are necessary. If the memory can provide the four complex values within one clock pulse and the matrix multiplication and scalar product operation are performed as a pipeline, one point of the function q² (u₁, u₂) can be calculated per clock pulse.

In FIG. 4, the method sequence is shown in the form of a diagram. The method can, for example, be implemented in a hardware accelerator 48. In an FFT block 50, the matrix product Y (2×2 matrix) is calculated approximately according to equation (9). The result is passed to two multiplication blocks 52, 54, in which the matrix z is calculated by multiplying with the matrices Gₜₓ⁻¹ and Gᵣₓ⁻¹. The precalculated coefficients a and b stored in memories 56, 58 are included here. The calculations take place sequentially for each index pair k, l.

In parallel thereto, the result of the FFT block 50 is passed to a further calculation block 60, in which the DML estimation function according to (10) is calculated by means of the matrices Y and Z̅. The function q² (u₁, u₂) thus obtained is stored in a memory 62 in the form of a two-dimensional map. Finally, in a search block 64, the maximum of this function is sought. The coordinates u₁ (=sin (Θ₁)) and u₂ (=sin (Θ₂)) specify the location angles Θ1 and Θ2 of the located object 24 (FIG. 3) and of the mirror object 24′.

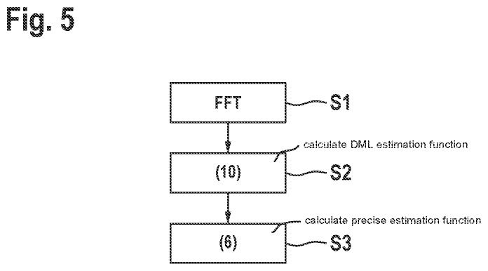

In order to reduce the runtime, the method can be divided into a rough search and a fine search, as shown in FIG. 5. In step S1, the two-dimensional FFT with beamforming takes place. In a subsequent step S2, the DML estimation function is calculated approximately according to calculation rule (10).

For the maximum found in this manner with low resolution, a precise estimation function, which forms the basis for a fine search, is then calculated according to calculation rule (6) in step S3, limited to a smaller domain of location angles Θ₁ and Θ₂

What is claimed is:

1. A method for angle estimation based on signals, transmitted and received after reflection on an object, of a radar sensor with angular resolution in at least one dimension, the radar sensor including a MIMO-enabled antenna array with at least three transmitting antennas and at least three receiving antennas, the method comprising:
estimating a location angle of a radar target using a cross-path model, in doing so, a necessary transmit-side and receive-side beamforming operation is approximately calculated using a fast Fourier transform.

2. The method according to claim 1, in which the cross-path model is represented by a control matrix A, the control matrix being broken down into a Kronecker product Aₜₓ ⊗Aᵣₓ of two submatrices, a first one, Aₜₓ, of the two submatrices representing an arrangement of the transmitting antennas and the other one, Aᵣₓ, of the two submatrices representing an arrangement of the receiving antennas, and the beamforming operation includes an approximate calculation of a matrix product Y=A^{H}ᵣₓ·X·A*^{tx} from the submatrices and a reception matrix X that specifies complex amplitudes of signals received with different combinations of the transmitting and receiving antennas.

3. The method according to claim 1, wherein gaps in a grid of the transmitting and receiving antennas are filled in using zero insertion.

4. The method according to claim 1, in which a grid of the transmitting and receiving antennas is refined using zero padding, and the fast Fourier transform takes place on the refined grid.

5. The method according to claim 2, wherein a fine search based on a precise beamforming operation takes place after an angle estimation based on the approximately calculated beamforming operation.

6. A radar sensor, comprising:
a transmitting and receiving device; and
a digital evaluation device, wherein the digital evaluation devices is configured for angle estimation based on signals, transmitted and received after reflection on an object, of a radar sensor with angular resolution in at least one dimension, the radar sensor including a MIMO-enabled antenna array with at least three transmitting antennas and at least three receiving antennas, the digital evaluation device configured to:
estimate a location angle of a radar target using a cross-path model, in doing so, a necessary transmit-side and receive-side beamforming operation is approximately calculated using a fast Fourier transform.

7. The radar sensor according to claim 6, wherein the radar sensor further comprises an internal evaluation stage and an external hardware accelerator in which at least portions of the estimation are implemented.
